(19) United States
(12) Patent Application Publication
(10) Pub. No.: US 2020/0380299 A1
(43) Pub. Date: Dec. 3, 2020

(54) Recognizing People by Combining Face and Body Cues

(71) Applicant: Apple Inc., Cupertino, CA (US)

(72) Inventors: Chunjia Hu, Cupertino, CA (US); Quan Yuan, San Jose, CA (US); Vinay Sharma, Palo Alto, CA (US)

(21) Appl. No.: 16/848,382

(22) Filed: Apr. 14, 2020

Related U.S. Application Data
(60) Provisional application No. 62/855,369, filed on May 31, 2019.

(51) Int. Cl. G06K 9/62; G06K 9/00; G06K 9/78

(52) U.S. Cl. CPC G06K 9/6255; G06K 9/6218; G06K 9/78; G06K 9/00362; G06K 9/00295

(57) ABSTRACT

Categorizing images includes obtaining a first plurality of images captured during a first timeframe, determining a vector representation comprising face characteristics and body characteristics of each of the people in each of the first plurality of images, and clustering the first plurality of vector representations. Categorizing images also includes obtaining a second plurality of images captured during a second timeframe, determining a vector representation comprising face characteristics and body characteristics for each person in each of the second plurality of images, and clustering the second plurality vector representations. Finally, a representative face vector is obtained from each of the first clusters and the second clusters based on the face characteristics and not the body characteristics, and identifying common people of the one or more people in the first plurality of images and the second plurality of images based on the representative face vectors.

### BACKGROUND

This disclosure relates generally to the field of media management, and more particularly to the field of recognizing people by face and body cues.

With the proliferation of camera-enabled mobile devices, users can capture numerous photos of any number of people and objects in many different settings and geographic locations. For example, a user may take and store hundreds of photos and other media items on their mobile device. However, categorizing and organizing those images can be challenging. Often, face recognition is used to identify a person across images, but face recognition can fail, e.g., in the event of a poor quality image and/or the pose of the person, such as if the person is looking away from the camera.

### SUMMARY

In one embodiment, a method for categorizing images is described. The method includes obtaining a first plurality of images captured during a first timeframe comprising one or more people, determining a vector representation comprising face characteristics and body characteristics of each of the one or more people in each of the first plurality of images, and clustering the first plurality of vector representations for the first plurality of images to obtain a first one or more clusters. The method also includes obtaining a second plurality of images captured during a second timeframe, determining a vector representation comprising face characteristics and body characteristics for each of one or more people in each of the second plurality of images, and clustering the second plurality vector representations for the second plurality of images to obtain a second one or more clusters. Finally, the method includes obtaining a representative face vector from each of the first one or more clusters and the second one or more clusters based on the face characteristics and not the body characteristics, and identifying common people of the one or more people in the first plurality of images and the second plurality of images based on the representative face vectors. That is, the face-only vectors that are representative of each of the clusters of face and body vectors from a particular moment.

In another embodiment, the method may be embodied in computer executable program code and stored in a non-transitory storage device. In yet another embodiment, the method may be implemented in an electronic device.

### BRIEF DESCRIPTION OF THE DRAWINGS

FIG. 1 shows, in block diagram form, a simplified electronic device according to one or more embodiments.

FIG. 2 shows, in flowchart form, a method for using identification of people within individual moments to identify people across moments, according to one or more embodiments.

FIG. 3 shows, in flowchart form, a method for identifying people across images from different times and/or locations, according to one or more embodiments.

FIG. 4 shows an example flowchart depicting a method for utilizing identification of a person in an image for image capture, according to one or more embodiments.

FIG. 5 shows, in block diagram form, a simplified multifunctional device according to one or more embodiments.

### DETAILED DESCRIPTION

This disclosure pertains to systems, methods, and computer readable media for recognizing people across images using face and body characteristics. A person can be recognized across images using characteristics of their face. Those characteristics can be embedded in a multidimensional embedding space based on the characteristics (e.g., the dimensions correspond to the characteristics). The identified face may be represented, for example, in n-dimensions represented by a vector. Images taken over a period of time can be grouped into “moments,” wherein each moment represents a set of spatiotemporally consistent images. Said another way, a “moment” consists of images taken within a same general location (e.g., home, work, a restaurant, or other significant location), and within a same timeframe of a predetermined length (e.g., half an hour, one hour, two hours, or up until the user of the image capture device moves to a different location). Images taken within a “moment” may be embedded in a multidimensional abstract embedding space—not only based on face characteristics, but also based on additional characteristics about the body (e.g., torso) of the people appearing in the images. These characteristics may include, for example, shape, texture, pose, and the like. Because torso characteristics are less likely to be consistent across moments (for example because people change clothes over the span of days, weeks, months, etc.), face data from the embedded data points may be used to cross reference the presence of particular people in images that span across distinct moments.

As an example, a user may capture two “moments” in a day, such as at home and at a restaurant. The first set of images captured at home may be analyzed to detect people in the images (that is, detect that one or more generic people are depicted in the image), and embed the faces into a multidimensional embedding space based on characteristics of the faces and bodies of the persons appearing in the images (that is, a body vector representing the characteristics of the face and body), for example based on a clustering algorithm. Clusters may be identified in the embedding space based on images of people for which the vectors are separated by a short distance in the embedding space. Each cluster may be considered as relating to a particular individual. Through the use of the combined body vector, the individuals may be recognizable, even in images where their faces are occluded, e.g., based on the use of the body data.

Later, the user may capture images at a restaurant, e.g., during a second identified moment. The second set of images may also be analyzed to detect faces in the images (that is, to detect that one or more generic faces are depicted in the image). The characteristics of the faces and bodies representative of those people in the second set of images may also be embedded into a second multidimensional abstract embedding space. The embedding space may be the same as the first space, but will not take into consideration the first set of images. Based on the clustering, individual people may be identified across images taken during the second moment. However, the individuals identified in this manner may not be identifiable across moments (e.g., if the same individuals also appeared in images captured during the first moment) because the images from the two distinct moments have not yet been considered together.

In order to identify and/or recognize people in images across distinct moments, a centroid may be determined for each cluster of the first embedding space and for each cluster of the second embedding space. The face data from each centroid is then embedded in a third embedding space, which considers just face data (that is, without consideration of the corresponding obtained body data). Based on clusters that form within the third embedding space, the identities of people appearing in images captured across distinct moments may be determined. Thus, the identity of persons represented by clusters that appear in the first embedding space and clusters that appear in the second embedding space may be linked together, e.g., based on the face data from their centroids appearing within the same cluster in the third embedding space.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed embodiments. In this context, it should be understood that references to numbered drawing elements without associated identifiers (e.g., 100) refer to all instances of the drawing element with identifiers (e.g., 100A and 100B). Further, as part of this description, some of this disclosure's drawings may be provided in the form of a flow diagram. The boxes in any particular flow diagram may be presented in a particular order. However, it should be understood that the particular flow of any flow diagram or flow chart is used only to exemplify one embodiment. In other embodiments, any of the various components depicted in the flow diagram may be deleted, or the components may be performed in a different order, or even concurrently. In addition, other embodiments may include additional steps not depicted as part of the flow diagram. The language used in this disclosure has been principally selected for readability and instructional purposes, and may not have been selected to delineate or circumscribe the disclosed subject matter. Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

It should be appreciated that in the development of any actual implementation (as in any development project), numerous decisions must be made to achieve the developers' specific goals (e.g., compliance with system and business-related constraints), and that these goals will vary from one implementation to another. It will also be appreciated that such development efforts might be complex and time consuming, but would nevertheless be a routine undertaking for those of ordinary skill in the art of image capture having the benefit of this disclosure.

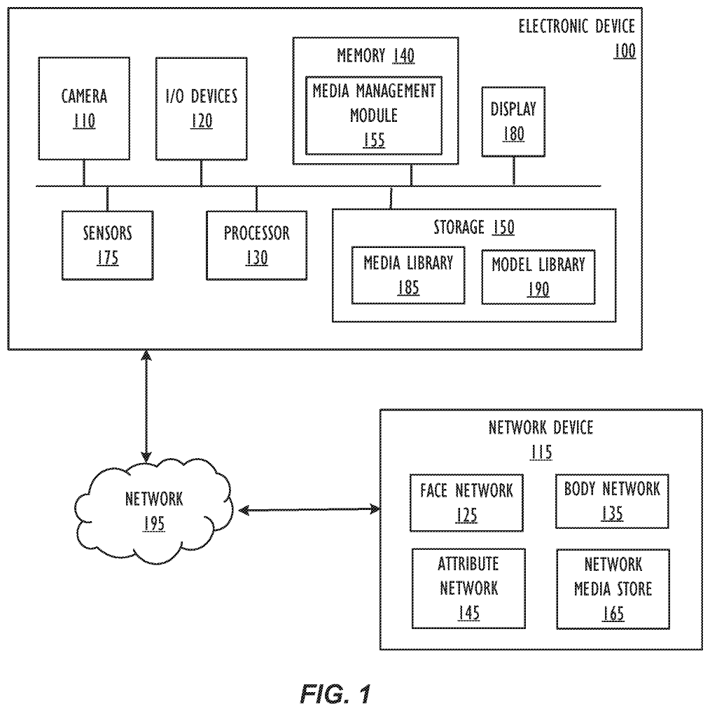

Referring to FIG. 1, a simplified block diagram of an electronic device 100 is depicted in accordance with one or more embodiments of the disclosure. Electronic device 100 may be part of a multifunctional device such as a mobile phone, tablet computer, personal digital assistant, portable music/video player, or any other electronic device that includes a camera system. Further, electronic device 100 may be part of a larger system of components that includes a camera 110 and a display 180. Electronic Device 100 may be connected to other devices across a network such as network device 115, and/or other mobile devices, tablet devices, desktop devices, as well as network storage devices such as servers and the like. Electronic device 100 may be configured to capture image data corresponding to a scene and use the captured image data to render views on a display 180 viewable by a user.

Electronic device 100 may include one or more sensors 175, which may provide information about a surrounding environment, such as contextual information. For example, sensors 175 may include sensors configured to detect brightness, depth, location, and other information regarding the environment. Electronic device 100 may also include a display 180, which may be an additive display. For example, display 180 may be a transparent or semi-opaque display, such as a heads-up display, by which an image may be projected over a transparent surface. Thus, display 180 may be comprised of a projector and a surface, or may just include the projector. Further, display 180 may be a transparent display, such as an LCD display and/or a head mounted display. Electronic device 100 may additionally include I/O devices 120, such as speakers and the like. In one or more embodiments, the various I/O devices 120 may be used to assist in image capture, as well as generating a pull request to obtain media items from a distal electronic device. According to one or more embodiments, I/O devices 120 may additionally include a touch screen, mouse, track pad, and the like.

Electronic device 100 may include a processor 130. Processor 130 may be a central processing unit (CPU). Processor 130 may alternatively, or additionally, include a system-on-chip such as those found in mobile devices and include zero or more dedicated graphics processing units (GPUs). Electronic device 100 may also include memory 140 and storage 150. Memory 140 and storage 150 may each include one or more different types of memory, which may be used for performing device functions in conjunction with processor 130. For example, memory 140 may include cache, ROM, and/or RAM. Memory 140 may store various programming modules during execution, including media management module 155. In one or more embodiments, storage 150 may comprise cache, ROM, RAM, and/or non-volatile memory, and may store media items in a media library 185. Media library 185 may include various types of media items, such as image files, video files, audio files, enhanced image files, and the like. An enhanced image may include a “snapshot image”, a first subset of image from a pre-capture image sequence, and a second subset of image from a post-capture image sequence, and wherein the first and second subsets of images may be played back as a video sequence (which may also include the snapshot image itself). The enhanced image may include a concurrently captured audio recording, according to one or more embodiments. Further, according to one or more embodiments, media library 185 may include a combination of types of media items. Media library 185 may include, for example, images captured by camera 110, as well as images received by electronic devices 100, for example by transmission.

Storage 150 may also include a model library 190 according to one or more embodiments. The model library 190 may include trained networks by which image data related to a person may embedded into a multidimensional abstract embedding space in order to identify people presented in images. In one or more embodiments, the model 190 may include a body embedding space, in which images of people are embedded based on characteristics of a face as well as a body, and a face specific embedding space, in which images of people are embedded based on face characteristics without consideration of the rest of the body. In one or more embodiments, the various models in the model library 190 may be utilized by the media management module 155 to categorize images as being associated with identities of people identified using the models.

Memory 140 may include instructions, such as computer readable code executable by processor 130 to perform various actions. For example, media management module 155 may include instructions that cause electronic device 100 to assist in managing media items captured by camera 110. Media management module 155 may manage media items captured, for example by camera 110, by storing captured media items, such as image files, video files, audio files, enhanced image files, and the like, such has those stored in media library 185. In one or more embodiments, additional data may be used to “tag” the images, such as geographic location, recognized faces or objects, date, time, and the like. Further, in one or more embodiments, media management module 155 may identify people depicted in the photographs. For example, or images captured within a particular time and within a particular location, people may be detected in the photos (e.g., a generic person shape may be identified). Then, a body network may be utilized.

According to one or more embodiments, the electronic device 100 may utilize resources of a network device 115. For example, the network device 115 may include storage or processing resources which may be utilized. Although network device 115 is depicted as a single device, it should be understood that network device 115 may be comprised of multiple devices. Further, the various components and modules described as being performed or hosted by network device 115 may be distributed across multiple network device 115 in any manner. Moreover, according to one or more embodiments, the various modules and components described as being hosted by network device 115 may alternatively or additionally be hosted by electronic device 100.

In one or more embodiments, network device 115 may include a network media store 165, in which images may be stored that may be categorized. Further, network device may include a face network 125. In one or more embodiments, the face network may be used to generate a face specific vector for an individual presented in an image. By contrast, body network 135 may be used to generate a vector representation of an individual based on face characteristics as well as body characteristics, and may be used to identify images containing a particular individual within a particular timeframe and/or location. Further, network device 145 may include attribute network 145 which may additionally be used to track body characteristics. As an example, attribute network 145 may be utilized to determine clothing categorization, dominant colors, and body pose associated with a particular individual. Because clothing and body pose are less likely to change within a “moment,” they may be utilized to categorize or cluster images within the “moment,” but not across “moments.”

According to one or more embodiments, the media management module 155 may identify an individual in a set of images captured within a common time and/or location (e.g., within an identified “moment”) using face and body characteristics. Because a person's clothing, pose, etc., are likely to be consistent within a common time and/or location, the face and body characteristics may be utilized to provide additional data in order to improve person identification in image data even in situations in which the face is not always visible. The media management module may generate a vector representation of each individual in each image based on the body network 135, the face network 125 (if face information is not already considered in the body network 135), and the attribute network 145. A person may be identified in the set of images based on a clustering algorithm that may be applied to the vector representations. The same may be done over multiple “moments” (that is, different timeframes, and/or different locations). Then, the clusters that form from each set of images may be cross-referenced utilizing only the face data. For example, a representative face vector may be obtained from the cluster, or may be obtained utilizing a representative image and the face network 125 for each cluster. Then, the various face vectors may be clustered to identify common clusters across “moments.” In one or more embodiments, a data for at least some of the data may be obtained, and applied to all images represented by each identified face cluster.

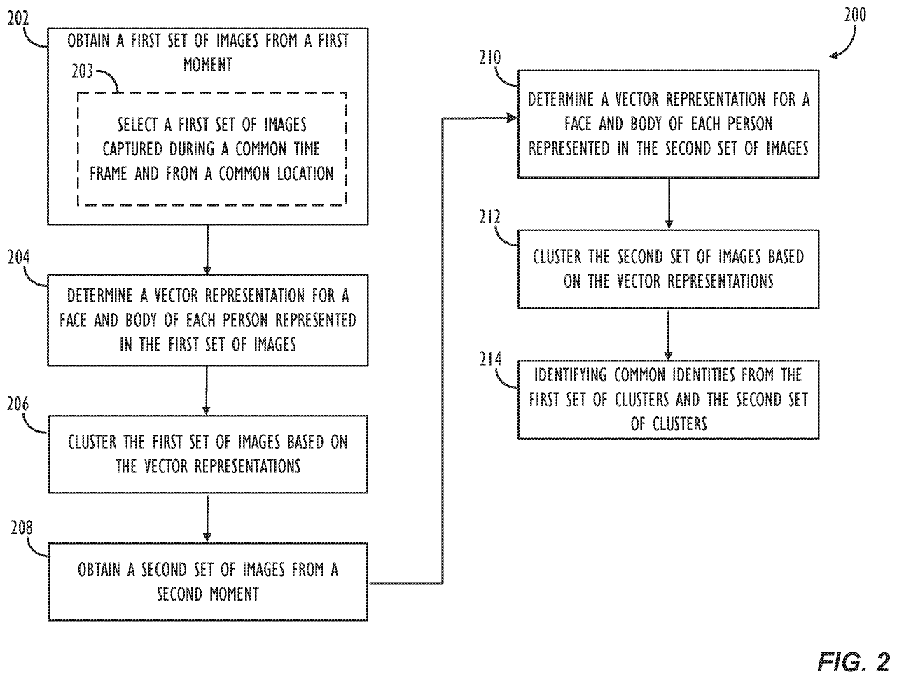

FIG. 2 shows, in flowchart form, an overview of a method 200 for using identification of people within individual moments to identify people across moments, according to one or more embodiments. With respect to each of the flowcharts described below (e.g., FIGS. 2-4), although the various actions are depicted in a particular order, in some embodiments the various actions may be performed in a different order. In still other embodiments, two or more of the actions may occur simultaneously. According to yet other embodiments, some of the actions may not be required or other actions may be included. For purposes of clarity, the flowchart will be described with respect to the various components of FIG. 1. However, it should be understood that the various actions may be taken by alternative components, according to one or more embodiments.

The flow chart begins at block 202, where the media management module 155 obtains a first set of images from a first moment. In one or more embodiments, the first moment includes a set of images captured within a specific timeframe. For example, the images may be captured within one hour, two hours, or the like. Optionally, in some embodiments, obtaining a first set of images from the first moment includes, at block 203, selecting a first set of images captured during a common timeframe from a common location. That is, in one or more embodiments, the first moment may be defined by the particular timeframe and a common location. The common location may include for example the particular building, a particular city, a particular geographic location, and the like.

At block 204, the media management module 155 determines a vector representation for a face and body of each person represented in the first set of images. That is, a person in a first image of the set of images may have representative vectors for each image in which person appears. As described above, the vector representation maybe may be, for example, an n-dimensional vector, wherein each vector value relates to a characteristic of the person. The vector representation may be obtained for example, from a neural network that is trained to identify characteristics of a face and body, such as body network 135, or a combination of body network 135 and face network 125, if face data is not trained in body network 135. Optionally, the attribute network 145 may also be utilized to determine the vector representation. In one of more embodiments, by utilizing face characteristics along with body characteristics for each image, the vector representation provides a better representation of the person in the image. This may be useful, for example, in situations where a person's face may not be visible, for example, due to lighting, pose, expressions, occlusions, or the like.

The flowchart continues at block 206, where the media management module 155 clusters the first set of images based on the vector representations. In one of more embodiments, the first set of images may be clustered example, by a clustering algorithm. Particularly, the image data associated with the people in the first set of images maybe clustered based on characteristics of the people identified in the images. In one or more embodiments, the clustering algorithm may be utilized to determine whether any of the vector representations are within a predetermined distance of each other. A group of representations within a predetermined distance of each other may be determined to belong to a particular cluster in the embedding space.

At block 208, the media management module 155 obtains a second set of images from a second moment. As described above, the second moment may include a second timeframe and/or a second particular location. That is, in one or more embodiments, the second set of images may be obtained from a same location as the first set of images but during a different timeframe. Similarly, the second set of images may be obtained from a different location but the same timeframe. As an example, the second set of images may be received by transmission from a different electronic device that is simultaneously capturing images during the time that the first set of images are captured.

At block 210, the media management module 155 determines a vector representation for a face and body of each person represented in the second set of images. As described above, the vector representation may be, for example, an n-dimensional vector or the like, and the vector representation may be determined for each instance in which a person is presented in an image within the set of images.

The flowchart continues at block 212, where the media management module 155 clusters the second set of images based on the vector representations. Specifically, image data corresponding to people identified in the second set of images may be clustered. In one or more embodiments, media management module 155 may cluster the second set of images based on the clustering algorithm. In one or more embodiments, the clustering algorithm may determine a distance between vectors representing people within the second set of images.

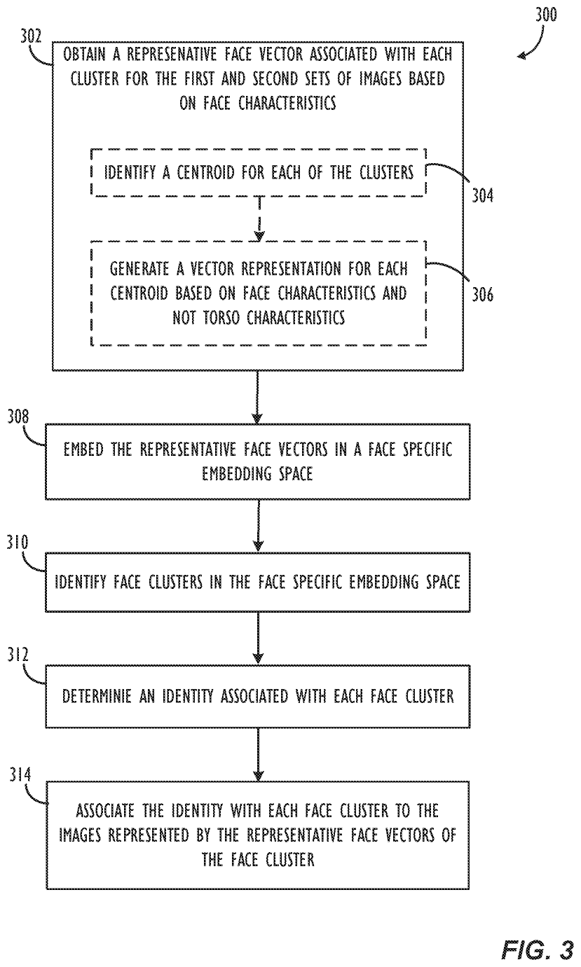

The flowchart concludes that block 214, where the media management module identifies common individuals from the first set of clusters and the second set of clusters. That is, the clusters identified at block 206 may form a first set of clusters, whereas the clusters identified at block 212 may form a second set of clusters. Generally, face characteristics (i.e., as opposed to body characteristics) from the people presented in the images may be used to identify common individuals across distinct clusters, as will be described below, with respect to FIG. 3.

FIG. 3 shows, in flowchart form, a method 300 for identifying common individuals in images captured across different times and/or locations (e.g., across distinct moments). Although the various actions are depicted in a particular order, in some embodiments the various actions may be performed in a different order. In still other embodiments, two or more of the actions may occur simultaneously. According to yet other embodiments, some of the actions may not be required or other actions may be included. For purposes of clarity, the flowchart will be described with respect to the various components of FIG. 1.

The flowchart begins at block 302, where management module 155 obtains a representative face vector associated with each cluster for the first set of images and each cluster for the second set of images based on face characteristics. That is, media management module 155 determines the vector of characteristics of the individuals based on face characteristics, and not on body characteristics. The representative face vectors associated with each cluster may be obtained in any number of ways. For example, a representative point in each of the clusters may be selected as a representative vector for the given cluster. As another example, an average of the vector values associated with face information for the vectors within the cluster may be utilized as a representative face vector. Then, the face a vector may be generated using the face characteristics of the vector (but not the body characteristics of the vector).

In one or more embodiments, as shown in block 304, media management module 155 may determine a centroid for each of the clusters. For example, a central embedding within the cluster may be identified, and the vector for that embedding may be used as the determined centroid for the given cluster. Then, at 306, the media management module may generate a vector representation for each centroid, e.g., based on the face characteristics and not the body characteristics. In one or more embodiments, the vector representation may be generated by referencing a face vector utilizing a face network 125. Additionally, or alternatively, the media management module 155 may generate the vector representation utilizing the face network 125 to generate a new vector representation.

The flowchart continues at block 308, where the media management module embeds the representative face vectors in a face specific embedding space. According to one or more embodiments, a clustering algorithm may be applied to the vector representations, e.g., in order to determine clusters of images that represent distinct people. The clustering algorithm may determine a distance between two face vectors, and may determine clusters when representative face vectors are within a predetermined distance of each other.

At block 310, media management module 155 identifies face clusters in the face-specific embedding space. According to one or more embodiments, the media management module 155 may utilize clustering algorithms in order to identify the face clusters. The face clusters may be determined, for example, based on vectors that are within a predetermined distance of each other in the face specific embedding space.

At block 312, the media management module 155, determines an identity associated with each face cluster. In one or more embodiments, the media management module 155, may utilize training data provided by a user which identifies the individuals represented by the vectors. Additionally, or alternatively, the media management module 155 may obtain user-provided identification data for one or more images and may propagate that to other images for which a common person is identified based on the face cluster.

The flowchart concludes at block 314, where the media management module 155 associates the identity with each face cluster to the images represented by the representative face vectors of the face cluster. That is, according to one or more embodiments, the media management module 155 can identify common individuals appearing in various images across moments, but based on face characteristics of the individuals (and not the body characteristics), as they are determined from the body clusters.

In one or more embodiments, the image is associated with the identities may be presented to a user in a user interface. For example, a photo app may identify individuals based on the represented identity. Thus, individuals that are looking away from the camera in a particular image may still be identified and presented according to their identity within the application. As an example, a collection of images associated with the identity of a particular person may be presented as such, and may include images in which the person's face is visible in the image, as well as images in which the person's face is not visible in the image.

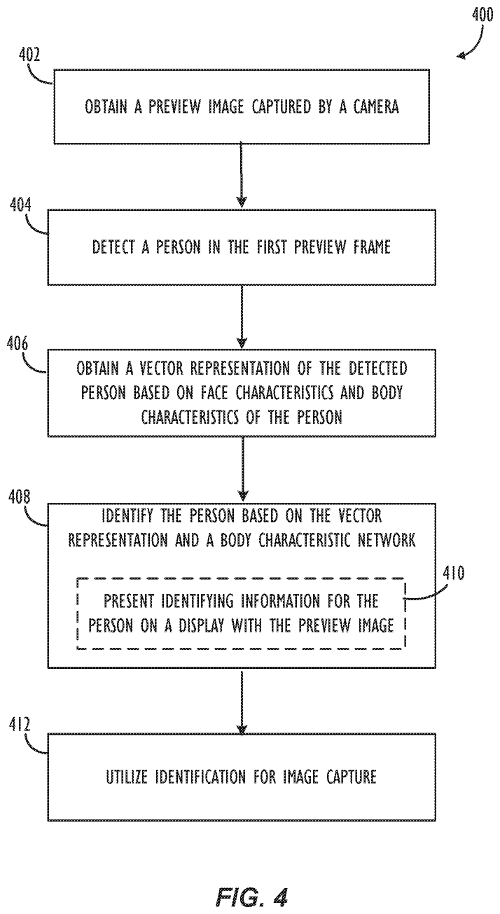

FIG. 4 shows a flowchart 400 for utilizing unique identifying information during an image capture process. Although the various actions are depicted in a particular order, in some embodiments the various actions may be performed in a different order. In still other embodiments, two or more of the actions may occur simultaneously. According to yet other embodiments, some of the actions may not be required or other actions may be included. For purposes of clarity, the flowchart will be described with respect to the various components of FIG. 1.

The flowchart begins at block 402, where the media management module 155 obtains a preview image captured by a camera. In one or more embodiments, the preview image may comprise image data, e.g., as is displayed on display 180 during a preview phase during the image capture process for capturing images by camera 110 of electronic device 100. Further, in one or more embodiments, the preview image may be comprised of a series of frames that are rendered and presented on the display 180.

The flowchart continues at block 404, where the media management module 155 detects person in the first preview frame. In one or more embodiments, the media management module may detect a generic person, such as a face of a person and/or a shape of a person in the image. That is, the media management module 155 may detect that a person is in the frame, without identifying the person in the frame.

At block 406, the media management module 155 obtains a vector representation of the detected person based on the face characteristics and body characteristics of the person during the display of a given preview image (e.g., the frames that are captured during the preview phase of the image capture process). As an example, the media management module may utilize the body network 135 and, optionally, the face network 125 and the attribute network 145 to obtain a vector representation of the face characteristics and body characteristics based on the image.

At block 408, the media management module 155 identifies the person based on the vector representation of the body characteristic embedding space. The preview frames may all be considered part of the same “moment” (i.e., since they are being captured during a continuous time interval) and, thus, the image data for people in the frames may be clustered based on face and body characteristics. In one or more embodiments, the media management module 155 may rely on the model library 190 to embed a vector representation of the person in the preview image to recognize or re-identify a previously recognized unique individual. The model library may include an identity associated with face clusters (e.g., clusters of embeddings based on face data) and/or body clusters (e.g., clusters of embeddings based on face and body data). In one or more embodiments, at 410, the management module presents identifying information for the person on the display with the preview image. For example, the identifying information may be displayed on display 180. Alternatively, the identifying information may be presented in other formats, such as audio, text overlays, and the like.

The flowchart concludes at 412, where the media management module 155 utilizes the identification of the person for image capture. In one or more embodiments identification of the person may be used for autofocus. For example, the portion of the image that includes a person of interest may be fed into an autofocus pipeline. In one or more embodiments, the portion of the preview frame that includes an identified person or an identified person of interest may be weighted for autofocus. As another example, a person may be re-identified if they leave the preview frame and then reenter the preview frame, even if face of the person is not visible when they reenter the preview frame. As such, the face and body characteristics may be utilized for reidentification. As yet another example, the identification or re-identification of an individual may be utilized to automatically capture an image without user intervention. In one or more embodiments, a particular frame from the preview stream may be selected that may include a particularly high quality representation of a particular person. As another example, a frame may be selected if a particular person of interest is identified in the frame.

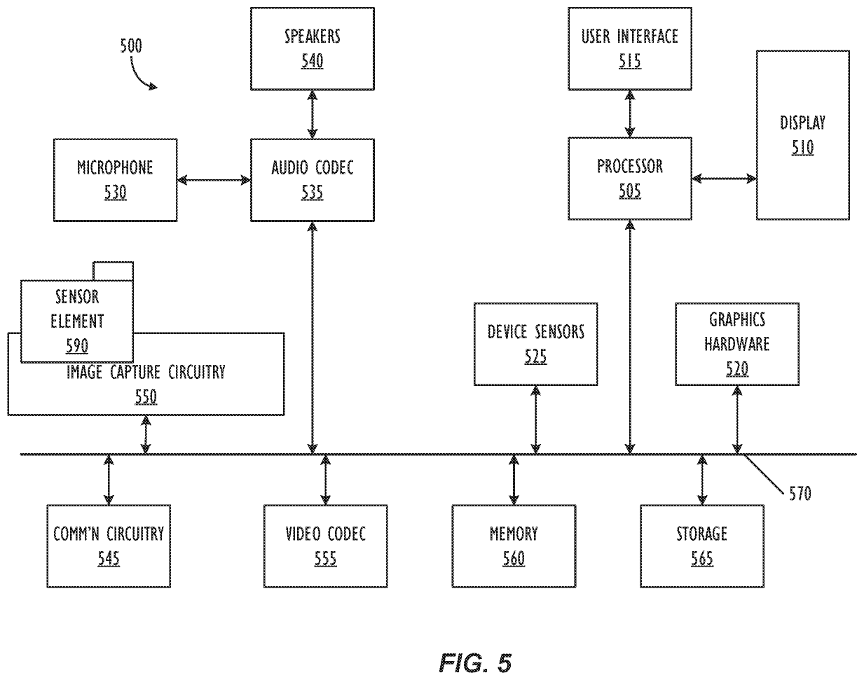

Turning to FIG. 5, a simplified functional block diagram of illustrative multifunction device 500 is shown according to one embodiment. Multifunction electronic device 500 may include processor 505, display 510, user interface 515, graphics hardware 520, device sensors 525 (e.g., proximity sensor/ambient light sensor, accelerometer and/or gyroscope), microphone 530, audio codec(s) 535, speaker(s) 540, communications circuitry 545, digital image capture circuitry 550, video codec(s) 555 (e.g., in support of digital image capture unit 550), memory 560, storage device 565, and communications bus 570. Multifunction electronic device 500 may be, for example, a digital camera or a personal electronic device such as a personal digital assistant (PDA), personal music player, mobile telephone, or a tablet computer.

Processor 505 may execute instructions necessary to carry out or control the operation of many functions performed by device 500 (e.g., such as the generation and/or processing of images and single and multi-camera calibration as disclosed herein). Processor 505 may, for instance, drive display 510 and receive user input from user interface 515. User interface 515 may allow a user to interact with device 500. For example, user interface 515 can take a variety of forms, such as a button, keypad, dial, a click wheel, keyboard, display screen and/or a touch screen. Processor 505 may also, for example, be a system-on-chip such as those found in mobile devices and include a dedicated graphics processing unit (GPU). Processor 505 may be based on reduced instruction-set computer (RISC) or complex instruction-set computer (CISC) architectures or any other suitable architecture and may include one or more processing cores. Graphics hardware 520 may be special purpose computational hardware for processing graphics and/or assisting processor 505 to process graphics information. In one embodiment, graphics hardware 520 may include a programmable GPU.

Image capture circuitry 550 may include lens assembly 580 associated with sensor element 590. Image capture circuitry 550 may capture still and/or video images. Output from image capture circuitry 550 may be processed, at least in part, by video codec(s) 555 and/or processor 505 and/or graphics hardware 520, and/or a dedicated image processing unit or pipeline incorporated within circuitry 565. Images so captured may be stored in memory 560 and/or storage 565.

Memory 560 may include one or more different types of media used by processor 505 and graphics hardware 520 to perform device functions. For example, memory 560 may include memory cache, read-only memory (ROM), and/or random access memory (RAM). Storage 565 may store media (e.g., audio, image and video files), computer program instructions or software, preference information, device profile information, and any other suitable data. Storage 565 may include one more non-transitory computer readable storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 560 and storage 565 may be used to tangibly retain computer program instructions or code organized into one or more modules and written in any desired computer programming language. When executed by, for example, processor 505 such computer program code may implement one or more of the methods described herein.

As described above, one aspect of the present technology is the gathering and use of data available from various sources to generate models of people and to categorize image data. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to request and receive image data from remote users. Accordingly, use of such personal information data enables users to share information and communicate easily. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence, different privacy practices should be maintained for different personal data types in each country.

The scope of the disclosed subject matter therefore should be determined with reference to the appended claims, along with the full scope of equivalents to which such claims are entitled.

1. A non-transitory computer readable medium comprising computer readable code executable by one or more processors to:
determine a first plurality of vector representations comprising face characteristics and body characteristics of each of the one or more people in each of a first plurality of images;
cluster the first plurality of vector representations for the first plurality of images to obtain a first one or more clusters;
determine a second plurality of vector representations comprising face characteristics and body characteristics for each of one or more people in each of a second plurality of images, wherein the second plurality of images are captured in a different timeframe than the first plurality of images;
cluster the second plurality vector representations for the second plurality of images to obtain a second one or more clusters;
obtain a representative face vector from each of the first one or more clusters and the second one or more clusters based on the face characteristics and not the body characteristics; and
identify a first person of the of the one or more people in both the first plurality of images and the second plurality of images based on the representative face vectors.

2. The non-transitory computer readable medium of claim 1, wherein the computer readable code to the representative face vector comprises computer readable code to:
determine a centroid for each of the first one or more clusters and the second one or more clusters, and
generate the representative face vector from each of the centroids.

3. The non-transitory computer readable medium of claim 1, wherein the computer readable code to identify the first person comprises computer readable code to:
embed the representative face vectors in a face-specific embedding space;
identify a face cluster in the face-specific embedding space comprising the representative face vectors;
determine an identity associated with one of the one or more face clusters; and
assign the determined identity to each image associated with the one or more first clusters for which the representative face vectors are part of the one of the one or more face clusters.

4. The non-transitory computer readable medium of claim 1, wherein the first plurality of images are captured within a predetermined time period and the first plurality of images are associated with a common location.

5. The non-transitory computer readable medium of claim 1, further comprising computer readable code to:
present the images in which the first person is identified on a user interface with an identity of the first person,
wherein the images in which the first person is identified include at least one image in which a face of the first person is not visible.

6. The non-transitory computer readable medium of claim 1, further comprising computer readable code to:
detect, based on the identification, that the first person is visible in a field of view of a camera; and
provide an indication that the one of the first person is in the field of view.

7. The non-transitory computer readable medium of claim 6, wherein a location of the first person is utilized for an autofocus operation for the capture of a subsequent one or more images.

8. The non-transitory computer readable medium of claim 6, wherein the computer readable code to detect that the one of the common people is visible further comprises computer readable code to identify the first person based on face characteristics and body characteristics of the first person.

9. A system for identifying a person in a plurality of images, comprising:
one or more processors; and
one or more computer readable media comprising computer readable code executable by one or more processors to:
determine a first plurality of vector representations comprising face characteristics and body characteristics of each of the one or more people in each of a first plurality of images;
cluster the first plurality of vector representations for the first plurality of images to obtain a first one or more clusters;
determine a second plurality of vector representations comprising face characteristics and body characteristics for each of one or more people in each of a second plurality of images, wherein the second plurality of images are captured in a different timeframe than the first plurality of images;
cluster the second plurality vector representations for the second plurality of images to obtain a second one or more clusters;
obtain a representative face vector from each of the first one or more clusters and the second one or more clusters based on the face characteristics and not the body characteristics; and
identify a first person of the of the one or more people in both the first plurality of images and the second plurality of images based on the representative face vectors.

10. The system of claim 9, wherein the computer readable code to the representative face vector comprises computer readable code to:
determine a centroid for each of the first one or more clusters and the second one or more clusters, and
generate the representative face vector from each of the centroids.

11. The system of claim 9, wherein the computer readable code to identify the first person comprises computer readable code to:
embed the representative face vectors in a face-specific embedding space;
identify a face cluster in the face-specific embedding space comprising the representative face vectors;
determine an identity associated with one of the one or more face clusters; and
assign the determined identity to each image associated with the one or more first clusters for which the representative face vectors are part of the one of the one or more face clusters.

12. The system of claim 9, further comprising computer readable code to:
detect, based on the identification, that the first person is visible in a field of view of a camera; and
provide an indication that the one of the first person is in the field of view.

13. The system of claim 12, wherein a location of the first person is utilized for an autofocus operation for the capture of a subsequent one or more images.

14. The system of claim 12, wherein the computer readable code to detect that the one of the common people is visible further comprises computer readable code to identify the first person based on face characteristics and body characteristics of the first person.

15. A method for identifying a person in a plurality of images, comprising:
determining a first plurality of vector representations comprising face characteristics and body characteristics of each of the one or more people in each of a first plurality of images;
clustering the first plurality of vector representations for the first plurality of images to obtain a first one or more clusters;
determining a second plurality of vector representations comprising face characteristics and body characteristics for each of one or more people in each of a second plurality of images, wherein the second plurality of images are captured in a different timeframe than the first plurality of images;
clustering the second plurality vector representations for the second plurality of images to obtain a second one or more clusters;
obtaining a representative face vector from each of the first one or more clusters and the second one or more clusters based on the face characteristics and not the body characteristics; and
identifying a first person of the of the one or more people in both the first plurality of images and the second plurality of images based on the representative face vectors.

16. The method of claim 15, further comprising:
determining a centroid for each of the first one or more clusters and the second one or more clusters; and
generating the representative face vector from each of the centroids.

17. The method of claim 15, further comprising:
embedding the representative face vectors in a face-specific embedding space;
identifying a face cluster in the face-specific embedding space comprising the representative face vectors;
determining an identity associated with one of the one or more face clusters; and
assigning the determined identity to each image associated with the one or more first clusters for which the representative face vectors are part of the one of the one or more face clusters.

18. The method of claim 15, wherein the first plurality of images are captured within a predetermined time period and the first plurality of images are associated with a common location.

19. The method of claim 15, further comprising:
presenting the images in which the first person is identified on a user interface with an identity of the first person,
wherein the images in which the first person is identified include at least one image in which a face of the first person is not visible.

20. The method of claim 15, further comprising:
detecting, based on the identification, that the first person is visible in a field of view of a camera; and
providing an indication that the one of the first person is in the field of view.
